(19) United States
(12) Patent Application Publication
(10) Pub. No.: US 2009/0177547 A1
(43) Pub. Date: Jul. 9, 2009

(54) METHOD FOR PROVIDING PERSONALIZED ADVERTISEMENTS

(75) Inventors: Sophie Piekarec, Nozay (FR); Stephane Betge Brezetz, Nozay (FR); Guy-Bertrand Kamga, Nozay (FR); Marie-Pascale Dupont, Nozay (FR)

Correspondence Address: FAY SHARPE/LUCENT, 1228 Euclid Avenue, 5th Floor, The Halle Building, Cleveland, OH, 44115-1843, US

(73) Assignee: Alcatel-Lucent via the Electronic Patent Assignment System (EPAS)

(21) Appl. No.: 12/350,326

(22) Filed: Jan. 8, 2009

(30) Foreign Application Priority Data
Jan. 8, 2008 (FR) 0800098

(51) Int. Cl. G06Q 30/00

(52) U.S. Cl. 705/14

(57) ABSTRACT

A method for distributing personalized media elements to media terminals, said method comprising the following operations, carried out within a media server:
determining at least one distribution criterion;
preselecting a group of media elements that meet the distribution criterion (or criteria);
for each media element, defining correlation criteria intrinsic with other media elements by defining metadata characteristic of the content of the media element as well as metadata characteristic of other media elements that may be combined with said media element;
selecting from among the preselected group media elements exhibiting an intrinsic correlation with one another;
concatenating the selected elements to form at least one eligible sequence;
choosing a sequence from among the eligible sequences,
distributing the chosen sequence to the media terminals.

The invention pertains to the field of content distribution: television-over-IP, mobile television, video-on-demand (VoD), etc, and more particularly to providing personalized advertisements within the context of content distribution.

For numerous advertisers, television has become an essential advertising medium, due to the large number of potential clients among television viewers, across many markets: food, automobiles, home appliances, entertainment, etc.

For years, advertisers have attempted to better target their potential customers. In conventional television that is broadcast, i.e. distributed simultaneously and indiscriminately by an emitter to a large number of receivers, targeting is generally limited to two criteria: the air time and the content of the broadcast.

It is now evident that the profile of television viewers varies depending on the air time. Children are a preferred target during morning hours; housewives are preferred by advertisers during the afternoon; and the whole family generally gathers to watch in the evening. Advertisers adjust the content of their advertising accordingly, such as food for children, home appliances for housewives, and entertainment for the family.

Advertisers also adjust the content of the advertisements to the broadcast that is underway, for which standard viewer profiles have been determined. For example, during the commercial breaks of romantic television series advertisers primarily target housewives.

In conventional television, however, targeted advertising relies on approximations, due to the essentially statistical criteria that it relies on, and the technical difficulty of measuring the advertising impact on the target audience, due to the one-way nature of the broadcast.

The Internet, and more recently, new content distribution methods, such as television-over-IP (IPTV), mobile television, video-on-demand (VoD), etc., on all sorts of media (television sets, computers, mobile terminals), have radically altered the behaviors of users and advertisers, who find themselves faced with new prospects for targeted advertising.

With respect to the Internet, various solutions exist to distribute advertisements in a targeted manner, and to measure the impact of advertising on users. For example, Microsoft adCenter and Google adWords, which operate on the “pay-per-click” principle, may be mentioned. Based on this principle, a publisher inserts an advertising window into a website including a sponsored link to a site determined by the advertiser, who in turn collects statistics regarding the users who clicked on that link, paying the publisher a fee for each click. Therefore, this is generally targeting based on the content (that of the site into which the advertising link is inserted), leading to targeting based on the user's profile.

The multiplicity and intrusive nature of the advertisements distributed over the Internet, however, have instilled distrust in users, so advertisers are basing major hopes on new distribution methods to ensure themselves a better return on their investment.

Given the large amount of data provided by users when they subscribe to multimedia services offered by telecommunications providers, advertisers are capable of establishing accurate profiles of their potential customer base, and as a result, distributing better-targeted advertisements than with conventional television.

Among the many existing solutions in distributing personalized advertisements, the American patent application 2007/0143787 (ALCATEL) may be cited, which describes a method for distributing advertisements at predetermined moments to subscribers of an interactive television service.

The inventors have decided that the existing solutions are insufficient to serving users in a fully satisfactory manner. In particular, the criteria which advertisers have conventionally relied upon to adapt their advertisements (the user's profile, air time, context of distribution, etc.) appear to be limited.

The invention intends to mitigate the insufficiencies of the existing solutions, by proposing a method for distributing personalized advertisements that makes it possible to maximize the impact on the viewer.

To that end, the invention, according to a first aspect, discloses a method for distributing personalized advertisements, comprising the following operations:

determining at least one distribution criterion;

preselecting a group of advertisements that meet the distribution criterion (or criteria);

selecting from among the preselected group advertisements exhibiting an intrinsic correlation with one another based on at least one predetermined correlation criterion;

concatenating the selected advertisements to form at least one eligible advertising sequence;

choosing a sequence from among the selected advertisements,

distributing the chosen sequence.

The advertisements of the sequence chosen in this manner exhibit an increased intrinsic correlation, which improves the targeting of the advertising effort, thereby maximizing its impact on viewers.

According to a second aspect, the invention discloses a system for distributing personalized advertisements, which comprises:

a module for defining intrinsic correlation criteria between advertisements,

a module for preselecting advertisements from among a group of advertisements based on distribution criteria,

a module for selecting advertisements, connected to the preselection module, and configured to
select from among the preselected group advertisements exhibiting an intrinsic correlation with one another based on at least one predetermined correlation criterion;
concatenate the selected advertisements to form a sequence;
choose a sequence from among the selected advertisements.

According to third and fourth aspects, respectively, the invention discloses a computer program product implemented on a data processing unit, said program comprising instructions for implementing the method described above; and a media server comprising such a processing unit.

Further purposes and advantages of the invention become apparent in the following description making reference to the indexed drawings, in which:

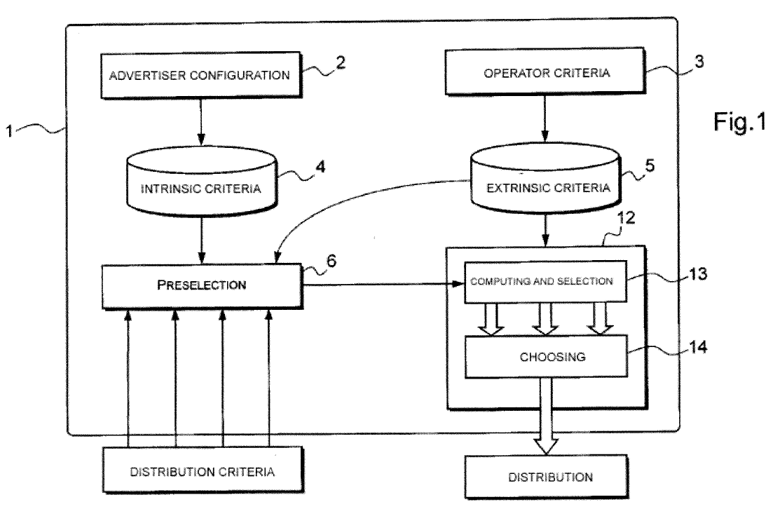

FIG. 1 is a diagram illustrating the architecture of an advertisement broadcasting system according to the invention;

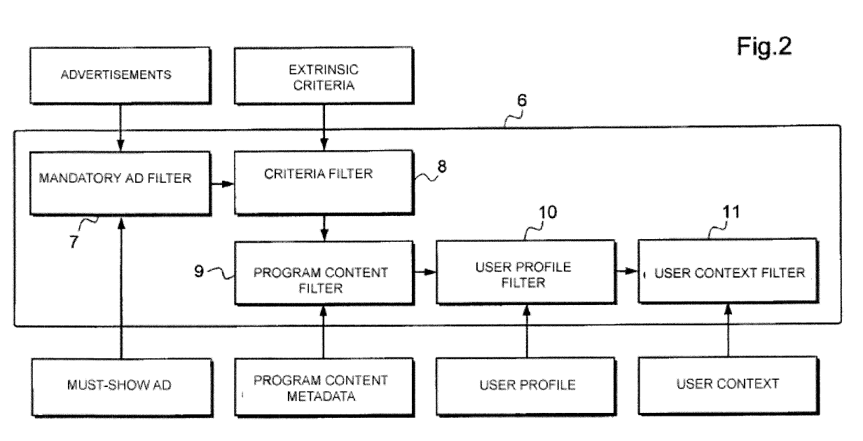

FIG. 2 is a diagram illustrating the architecture of an advertisement preselection module using various criteria.

FIG. 1 depicts a system 1 for distributing advertisements within the context of content distribution, such as television-over-IP, mobile television, VoD, etc. The architecture of this system 1 is designed to distribute personalized advertisements to subscribers of content distribution services, independent of the distribution medium (television set, computer, mobile terminals), and more precisely to distribute sequences of advertisements that are intrinsically correlated, i.e. are based on at least one correlation parameter specific to the advertisements themselves.

This system 1 comprises two configuration modules 2, 3 used for defining advertisement selection rules from among a predefined set of advertisements in order to form correlated advertisement sequences.

More precisely, the system comprises a first configuration module 2 for configuring the advertisements themselves, accessible to the advertiser and enabling it, via a graphical interface, to carry out the following operations for defining intrinsic correlation criteria, to with:

defining metadata characteristic of the content of the advertisement, particularly the topic of the advertisement and a set of key terms associated with that topic and describing the content of the advertisement,

specifying metadata characteristic of the content of other surrounding advertisements (i.e. those which may be combined with the present advertisement within a single sequence), such as topics or key terms describing the content of the advertisements, to be preferred when choosing these advertisements;

potentially specifying metadata characteristic of the content of other advertisements related to the present advertisement, such as topics or key terms describing the content of the advertisements, to be excluded when choosing these advertisements.

These operations may, for example, lead to the creation of a tag associated with the advertisement, containing a series of pieces of metadata ordered into triplets and containing three series of terms as defined or specified by means of the configuration module.

For example, within the field of automobiles, an advertisement touting the merits of a vehicle could be configured in the following manner:

Metadata characteristic of the advertisement: vehicle, driving, road;

Metadata to prefer: +GPS, +car accessories, +gas station, +trailer

Metadata to exclude: −road safety, −train, −airplane, −bus.

The tag associated with the advertisement would therefore be set as follows:

[‘vehicle, driving, road’, ‘+GPS, +car accessories, +gas station, +trailer’, ‘−road safety, −train, −airplane, −bus’]

The syntax proposed is provided by way of example. Each piece of metadata to prefer has thereby been assigned a “+” prefix, and every piece of metadata to exclude has been assigned a “−” prefix, so as to enable the system to recognize which class of metadata the term following the prefix must be assigned to: preferred for the “+” prefix, excluded for the “−” prefix.

The system 1 further comprises a database 4 for storing tags associated with advertisements processed by means of the advertiser's configuration module 2, and connected to said module.

System 1 also comprises a rules configuration module 3, for establishing rules such as price, duration, priorities, etc. linked to the use of advertisements. This module is accessible to the provider and allows it to implement these rules via a graphic interface.

The system 1 further comprises a database 5, connected to the rule configuration module 3, in which are stored the rules established by the provider via this module 3.

The system 1 further comprises an advertisement preselection module 6, which selects from among a set of advertisements a preselection of advertisements based on at least one distribution criterion, independent of the intrinsic correlation criteria and rules as defined above, and chosen, for example, among the presence of a must-distribute advertisement within the sequence to be distributed, the content of a program (in the form of metadata drawn from an associated description) within which (or at least in relation with which) the advertising effort is performed, the subscriber's profile, and the subscriber's context.

As is depicted in more detail in FIG. 2, the preselection module 6 comprises a series of filters 7, 8, 9, 10, 11, associated with each distribution criterion, which operate in a series depending on a predetermined order of priority (the priority descending from left to right in the figure), and enabling a choice from among the set of advertisements of a successive assortment of advertisements that meet the set of criteria.

The preselection module 6 is linked to databases 4 and 5 which provide it, upon request, with the correlation criteria and rules set out respectively by the advertiser and the provider with regards to the preselected advertisements.

Once the preselection has been made, it is transmitted, along with the correlation criteria associated with each advertisement, with a selection module 12 comprising two sub-modules 13, 14, to with:

a computing sub-module 13 which chooses from among the preselection a selection of advertisements exhibiting an intrinsic correlation with one another based on at least one of the correlation criteria as defined above, and concatenates the selected advertisements to form eligible correlated advertisement sequences (i.e those which may be selected to be distributed).

a selection sub-module 14, which the computing sub-module 13 provides with at least one eligible sequence, and which chooses from among the eligible sequences the selection of a sequence to be distributed based on at least one of the extrinsic criteria as defined above.

The sequence chosen in this manner is then distributed. It should be noted that the advertisements distributed within a single sequence are not necessarily in the same format, but rather may be in different formats (for example: scrolling text, video, audio, etc.).

The system just described, and its implementation, make it possible to achieve a better personalization of the distributed advertisement sequences, in that correlation criteria intrinsic to the advertisements themselves are taken into account.

For example, it is possible, using this solution, to distribute targeted advertising sequences regarding automobiles, each advertisement therein being related to one another on the topic of automobiles, while preventing advertisements deemed undesirable from polluting the sequence by reducing the impact of the surrounding advertisements (for example, an advertisement for a rail transport company in the middle of a sequence of advertisements that includes an advertisement for seasonal vacation vehicle rental, an advertisement for a car magazine, and an advertisement for an upcoming automobile sporting event).

The operations described above may be carried out by means of a computer program implemented on a processing unit of a media server, said program comprising instructions for implementing these operations.

1. A method for distributing media elements to media terminals, said method comprising the following operations, carried out within a media server:
determining at least one distribution criterion;
preselecting a group of media elements that meet the distribution criterion (or criteria);
for each media element, defining correlation criteria intrinsic with other media elements by defining metadata characteristic of the content of the media element as well as metadata characteristic of other media elements that may be combined with said media element;
selecting from among the preselected group media elements exhibiting an intrinsic correlation with one another;
concatenating the selected elements to form at least one eligible sequence;
choosing a sequence from among the eligible sequences,
distributing the chosen sequence to the media terminals.

2. A method according to claim 1, wherein the metadata comprise key terms describing the content of the media elements.

3. A method according to claim 1, wherein the distribution criteria are chosen from among a group comprising a must-distribute media element, the content of a program in connection with which it is distributed, a subscribers profile, and the subscriber's context.

4. A method according to claim 1, wherein the said sequence is chosen based on rules of use.

5. A method according to claim 1, wherein the media elements of a single sequence exhibit different formats.

6. A system (1) for distributing personalized media elements, comprising:
a module (2) for defining intrinsic correlation criteria among media elements,
a module (6) for preselecting media elements from among a set of media elements based on distribution criteria;
a module (12) for selecting media elements, connected to the preselection module (6), and configured to
select from among the preselected group media elements exhibiting an intrinsic correlation with one another based on at least one predetermined correlation criterion;
concatenate the selected media elements to form an eligible sequence;
choose a sequence from among the eligible sequences.

7. The method according to claim 1 wherein the method is implemented as a computer program product implemented on a data processing unit, said program comprising instructions for implementing operations of the method, when said program is run on a computer.

8. The method according to claim 7 wherein the program is implemented as a media server comprising a processing unit.
